(19) United States
(12) Patent Application Publication
(10) Pub. No.: US 2026/0089447 A1
(43) Pub. Date: Mar. 26, 2026

(54) SMART GLASSES FOR HEARING ASSISTANCE, HEARING ASSISTANCE METHOD, AND AUXILIARY SYSTEM

(71) Applicant: SOLOS TECHNOLOGY (SHENZHEN) LIMITED, Shenzhen (CN)

(72) Inventors: Kwok Wah Law, Shenzhen (CN); Kwun Lam Tai, Shenzhen (CN); Chi Sum Yu, Shenzhen (CN); Kenneth Fan, Somerville, MA (US); Wai Kuen Kenny Cheung, Shenzhen (CN)

(21) Appl. No.: 19/403,361

(22) Filed: Nov. 28, 2025

Related U.S. Application Data
(63) Continuation-in-part of application No. PCT/CN2024/091091, filed on May 4, 2024.

(30) Foreign Application Priority Data
May 31, 2023 (CN) 202310639291.8

(51) Int. Cl. H04R 25/02; H04M 3/42; H04R 25/00

(52) U.S. Cl. CPC H04R 25/02; H04M 3/42391; H04R 25/356; H04R 25/456; H04R 25/554; H04R 25/603; H04R 2225/61; H04R 2430/01; H04R 2499/15

(57) ABSTRACT

Smart glasses for hearing assistance, a hearing assistance method, and an auxiliary system are provided. The smart glasses include two temples, a sound pickup device, a plurality of speakers and a wireless communication module. The sound pickup device includes at least one microphone, which is configured to obtain first voice data from a first preset direction. The wireless communication module is configured to amplify the first voice data to obtain amplified voice data, and send the amplified voice data to a target speaker for playing. The target speaker and the at least one microphone are respectively disposed on different temples. The present disclosure realizes a real-time hearing assistance function based on the smart glasses, thereby enhancing user engagement.

### CROSS-REFERENCE TO RELATED APPLICATIONS

The present application is a continuation-in-part application of PCT Application No. PCT/CN2024/091091, filed on May 4, 2024, which claims the priority of Chinese Patent Application No. 202310639291.8, filed on May 31, 2023, the entire contents of which are hereby incorporated by reference.

### TECHNICAL FIELD

The present disclosure relates to the technical field of smart glasses, and particularly to smart glasses for hearing assistance, a hearing assistance method, and an auxiliary system.

### BACKGROUND

With the development of computer technology, smart glasses have become increasingly popular. However, conventional smart glasses are costly, heavy, and beyond their inherent functions as daily eyeglasses, they typically only provide the functions of listening to music and making/receiving phone calls. This results in relatively limited functionality with minimal user engagement.

### SUMMARY

Embodiments of the present disclosure provide smart glasses for hearing assistance, a hearing assistance method, and an auxiliary system, which are used to realize a real-time hearing assistance function based on smart glasses, thereby enhancing user engagement.

One embodiment of the present disclosure provides smart glasses for hearing assistance, including: two temples, a sound pickup device, a plurality of speakers and a wireless communication module;
the plurality of speakers and the sound pickup device are disposed on at least one of the two temples, the wireless communication module is disposed in a cavity of either one of the two temples and electrically connected to the sound pickup device and the plurality of speakers, and the sound pickup device includes at least one microphone;
the at least one microphone is configured to obtain first voice data from a first preset direction; and
the wireless communication module is configured to amplify the first voice data to obtain amplified voice data, and send the amplified voice data to a target speaker of the plurality of speakers for playing; and wherein the target speaker and the at least one microphone are respectively disposed on different temples.

One embodiment of the present disclosure further provides a hearing assistance method based on smart glasses, and the smart glasses include two temples, a wireless communication module, and a sound pickup device and a plurality of speakers electrically connected to the wireless communication module; the sound pickup device includes at least one microphone; and the hearing assistance method includes:
obtaining first voice data from a first preset direction through the at least one microphone;
amplifying the first voice data by the wireless communication module to obtain amplified voice data; and
playing the amplified voice data through a target speaker of the plurality of speakers, and wherein the target speaker and the at least one microphone are respectively disposed on different temples.

One embodiment of the present disclosure further provides an auxiliary system, including smart glasses and a smart mobile terminal,
the smart glasses include two temples, a sound pickup device, a plurality of speakers and a wireless communication module, and wherein the plurality of speakers and the sound pickup device are disposed on at least one of the two temples; the wireless communication module is disposed in a cavity of either one of the two temples and electrically connected to the sound pickup device and the plurality of speakers; and the sound pickup device includes at least one microphone;
the wireless communication module is configured to control switching of a working mode of the smart glasses in response to a user's control operation, and the working mode includes a hearing assistance mode and a translation mode;
the at least one microphone is configured to, in the hearing assistance mode or the translation mode, obtain first voice data from a first preset direction;
the wireless communication module is configured to, in the hearing assistance mode, amplify the first voice data to obtain amplified voice data, and send the amplified voice data to a target speaker of the plurality of speakers for playing; and wherein the target speaker and the at least one microphone are respectively disposed on different temples;
the wireless communication module is further configured to, in the translation mode, send the first voice data to the smart mobile terminal;
the smart mobile terminal is configured to receive the first voice data, and send second voice data to the wireless communication module; and wherein the second voice data is obtained by translating the first voice data; and
the wireless communication module is further configured to receive the second voice data sent by the smart mobile terminal, and send the second voice data to the target speaker for playing.

In embodiments of the present disclosure, by using the at least one microphone of the smart glasses to obtain the first voice data from the first preset direction, and using the wireless communication module of the smart glasses to amplify the first voice data and send the amplified first voice data to the target speaker of the plurality of speakers for playing, where the target speaker and the at least one microphone are respectively disposed on different temples, the real-time hearing assistance function based on the smart glasses is realized, thereby expanding the functions of the smart glasses and enhancing the user engagement. Meanwhile, since voice data to be amplified is obtained from a specific direction by a microphone on one side, and the amplified voice data is played by a speaker on the other side, echo can be reduced and the quality of played sound can be improved.

### BRIEF DESCRIPTION OF DRAWINGS

In order to more clearly illustrate the technical solutions in the embodiments of the present disclosure or prior art, brief introductions to the drawings described in the embodiments or the prior art are as follows. Apparently, the following drawings are merely some embodiments of the present disclosure; for those skilled in the art, other drawings can be obtained based on the drawings without expending creative efforts.

FIG. 1 is a structural schematic diagram of smart glasses according to one embodiment of the present disclosure.

FIG. 2 is an internal structural schematic diagram of smart glasses according to another embodiment of the present disclosure.

FIG. 3 is an external structural schematic view of the smart glasses shown in FIG. 2.

FIG. 4 is a schematic view of an auxiliary system according to one embodiment of the present disclosure.

FIG. 5 is a hardware structural schematic diagram of a smart mobile terminal of the auxiliary system shown in FIG. 4.

FIG. 6 is a schematic diagram of an implementation flow of a hearing assistance method based on smart glasses according to one embodiment of the present disclosure.

FIG. 7 is a schematic diagram of sound beam directions of a microphone in different working modes in the hearing assistance method based on smart glasses according to one embodiment of the present disclosure.

FIG. 8 is a schematic diagram of an operating status and a working mode of the smart glasses in the hearing assistance method based on smart glasses according to one embodiment of the present disclosure.

FIG. 9 is a schematic diagram of a processing procedure of voice signals in a call mode in the hearing assistance method based on smart glasses according to one embodiment of the present disclosure.

FIG. 10 is a schematic diagram of a processing procedure of voice signals in a hearing assistance mode in the hearing assistance method based on smart glasses according to one embodiment of the present disclosure.

FIG. 11 is a schematic diagram of feedback cancellation processing in FIG. 10.

### DESCRIPTION OF EMBODIMENTS

In order to make the purpose, technical solutions and advantages of the present disclosure more clearly understood, the technical solutions of the present disclosure are described clearly and completely below in conjunction with the accompanying drawings of the present disclosure. Apparently, the described embodiments are only part of the embodiments of the present disclosure, not all of the embodiments. Based on the embodiments of the present disclosure, all other embodiments obtained by those of ordinary skill in the art without creative efforts are within the protection scope of the present disclosure.

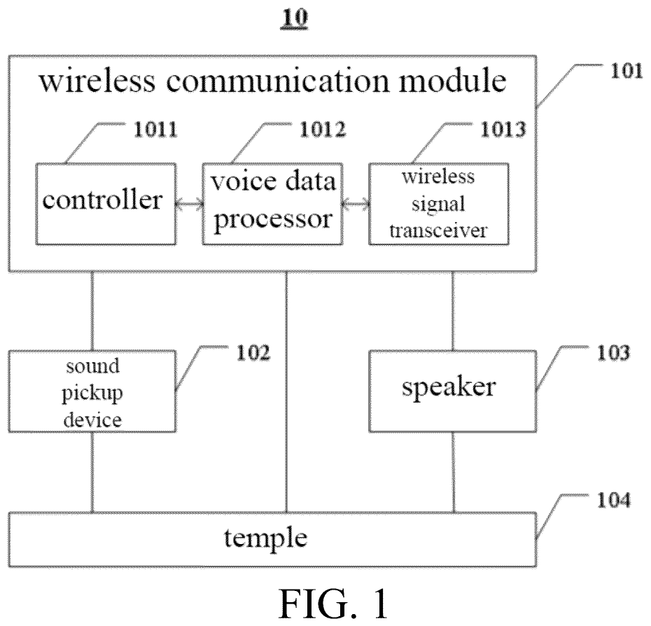

Referring to FIG. 1, FIG. 1 is a structural schematic diagram of smart glasses according to one embodiment of the present disclosure. For ease of explanation, only parts relevant to the embodiment of the present disclosure are shown in FIG. 1. As shown in FIG. 1, smart glasses 10 include: a wireless communication module 101, a sound pickup device 102, a plurality of speakers 103, and two temples 104. The wireless communication module 101 is electrically connected to the sound pickup device 102 and the plurality of speakers 103.

The plurality of speakers 103 and the sound pickup device 102 are disposed on at least one of the two temples 104. The wireless communication module 101 is disposed in a cavity of either one of the two temples 104 and is electrically connected to the sound pickup device 102 and the plurality of speakers 103.

The sound pickup device 102 includes at least one microphone. Optionally, the pickup device 102 includes at least one directional microphone. Further, the sound pickup device 102 may also include at least one omnidirectional microphone. For example, the sound pickup device 102 may be a microphone array that includes at least one directional microphone and/or at least one omnidirectional microphone.

Further, the wireless communication module 101 may include, but is not limited to: a controller 1011, a voice data processor 1012, and a wireless signal transceiver 1013. The controller 1011 is mainly used for UI (User Interface), task operations, and real-time operating system operations. The voice data processor 1012 is mainly configured to perform operations of time-consuming signal processing algorithms and Bluetooth wireless communication algorithms.

The wireless signal transceiver 1013 may send data using, but is not limited to, at least one of the Bluetooth protocol, WiFi (Wireless Fidelity) protocol, NFC (Near Field Communication) protocol, ZigBee, DLNA (DIGITAL LIVING NETWORK ALLIANCE) protocol, UWB (Ultra Wideband) protocol, RFID (Radio Frequency Identification) protocol, and CMC (Cellular Mobile Communication) protocol.

Specifically, the at least one microphone is configured to obtain first voice data from a first preset direction.

The wireless communication module 101 is configured to amplify the first voice data to obtain amplified voice data, and send the amplified voice data to a target speaker of the plurality of speakers 103 for playing. The target speaker and the at least one microphone are respectively disposed on different temples.

In the present embodiment, by using the at least one microphone of the smart glasses to obtain the first voice data from the first preset direction, and using the wireless communication module of the smart glasses to amplify the first voice data and send the amplified first voice data to the target speaker of the plurality of speakers for playing, where the target speaker and the at least one microphone are respectively disposed on different temples, a real-time hearing assistance function based on the smart glasses is realized, thereby expanding the functions of the smart glasses and enhancing the user engagement. Furthermore, since no additional hearing assistance devices need to be installed on the smart glasses, the weight of the smart glasses can be reduced, power consumption can be decreased, and the manufacturing cost of the smart glasses can be lowered. Meanwhile, since voice data to be amplified is obtained from a specific direction by a microphone on one side, and the amplified voice data is played by a speaker on the other side, echo can be reduced and the quality of played sound can be improved.

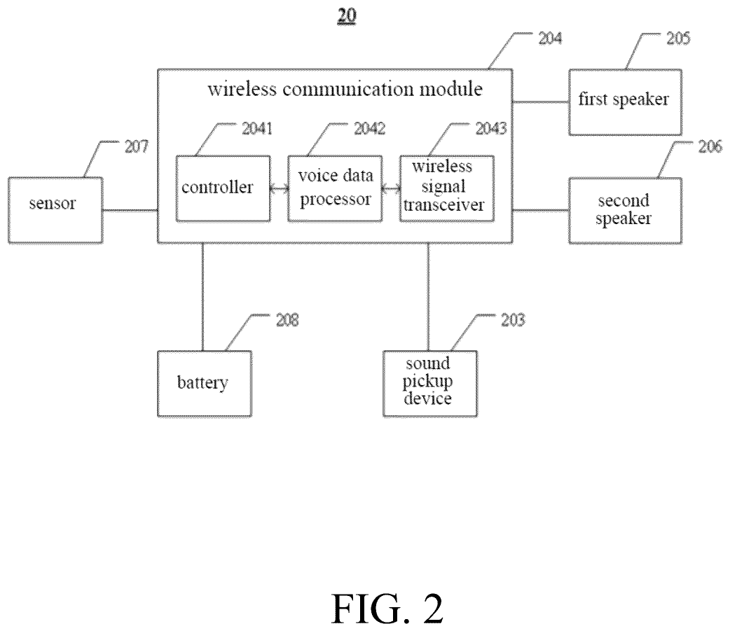

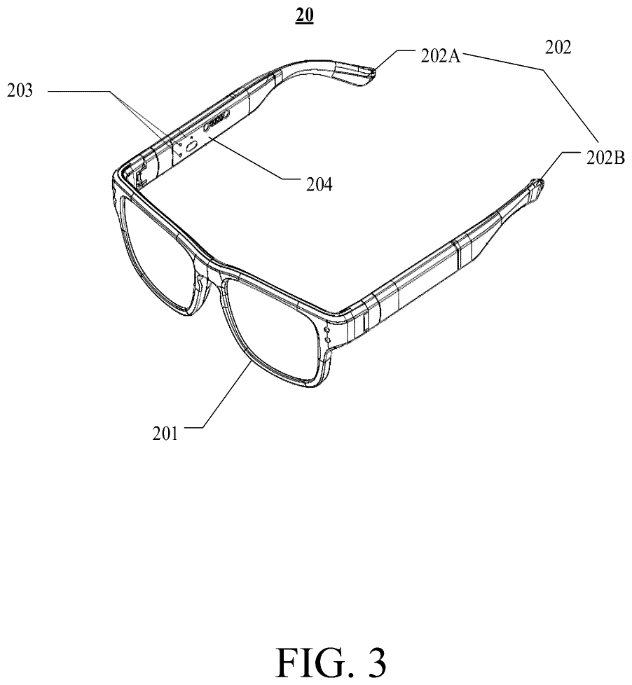

Referring to FIG. 2 and FIG. 3, FIG. 2 is an internal structural schematic diagram of smart glasses according to another embodiment of the present disclosure, and FIG. 3 is an external structural schematic view of the smart glasses shown in FIG. 2. As shown in FIG. 2 and FIG. 3, smart glasses 20 include a frame 201, two temples 202, at least one sound pickup device 203 (only one is shown in figures for ease of understanding), a first speaker 205, a second speaker 206, and a wireless communication module 204.

The temples 202 are connected to the frame 201. The first speaker 205, the second speaker 206, and the at least one sound pickup device 203 are disposed on at least one of the two temples 202. The wireless communication module 204 is disposed in a cavity of either one of the two temples 202 and is electrically connected to the first speaker 205, the second speaker 206, and the at least one sound pickup device 203.

The sound pickup device 203 is configured to obtain first voice data from a first preset direction.

The wireless communication module 204 is configured to amplify the first voice data to obtain amplified voice data, and send the amplified voice data to a target speaker of the first speaker 205 and the second speaker 206 for playing. The target speaker and the sound pickup device 203 are respectively disposed on different temples.

The wireless communication module 204 is further configured to control the switching of a working mode of the smart glasses. The working mode includes a call mode, a hearing assistance mode, and a translation mode.

The sound pickup device 203 includes at least one directional microphone and/or at least one omnidirectional microphone. When the sound pickup device 203 is the omnidirectional microphone, the wireless communication module 204 is further configured to, in the call mode, perform a first beamforming process on the voice data obtained by the at least one sound pickup device 203, such that a sound beam of the at least one sound pickup device 203 is directed downward, that is, corresponding to a user's mouth, in this case, a sound source of the voice data may be a wearer of the smart glasses; and is further configured to, in the hearing assistance mode and the translation mode, perform a second beamforming process on the voice data obtained by the at least one sound pickup device 203, such that the sound beam of the at least one sound pickup device 203 is directed forward. In this case, the sound source of the voice data may be a conversation partner of the wearer of the smart glasses. The wireless communication module 204 can automatically control the omnidirectional microphone to be directed to a corresponding direction according to a switched working mode after switching the working mode.

Optionally, the two temples 202 include a first temple 202A and a second temple 202B. A front end of the first temple 202A and a front end of the second temple 202B are respectively connected to two sides of the frame 201, and the at least one sound pickup device 203 is installed at the front end of the first temple 202A.

The first speaker 205 and the second speaker 206 are configured to output voice data or music data. The voice data includes voice data obtained by the sound pickup device 203 after being processed by the wireless communication module 204, and call voice data sent by the smart mobile terminal and received by the wireless communication module 204. The music data includes music data sent by the smart mobile terminal and received by the wireless communication module 204.

In one embodiment, the first speaker 205 is installed on the first temple 202A, and an output port of the first speaker 205 is located at a rear end of the first temple 202A.

The second speaker 206 is installed on the second temple 202B, and an output port of the second speaker 206 is located at a rear end of the second temple 202B.

In the hearing assistance mode and the translation mode, only an open speaker located on one temple is used to output voice data, thereby achieving the effect of reducing echo.

For example, in the hearing assistance mode, if the sound pickup device of the smart glasses is located on the left temple, the amplified voice signal is output only to the speaker configured on the right temple for playing; if the sound pickup device is located on the right temple, the amplified voice signal is output to the speaker configured on the left temple for playing.

Optionally, in another embodiment of the present disclosure, when each temple is provided with the microphone and the speaker, each microphone and each speaker are provided with their own corresponding unique identity information, and corresponding relationships between the unique identity information of each microphone and each speaker and respective positions thereof are stored in the wireless communication module 204. The wireless communication module 204 is further configured to determine an installation position of the microphone obtaining the first voice data according to the corresponding relationships, and further determine the target microphone according to the installation position and the corresponding relationships.

It is understandable that in the hearing assistance mode, the voice signal in front of the wearer can be independently amplified by the smart glasses without connecting to any mobile terminal device.

Since the sound pickup device is installed at the front end of at least one temple, and the output port of each speaker is installed at the rear end of the temple, sufficient distances can be formed between the sound pickup device and the output port of each speaker. Therefore, the occurrence of loop formation between the sound pickup device and the speakers can be effectively reduced, and the probability of echo and howling during use can be lowered.

In addition, after a user wears the smart glasses, the rear ends of the temples are closest to the user's ears. By installing the output ports of the speakers at the rear ends of the temples, the output ports of the speakers can be brought closest to the user's ears, thereby improving the efficiency of sound output.

In one embodiment, the first speaker 205 and the second speaker 206 are mono speakers. The mono speakers installed on the two temples can be combined to achieve a stereo sound effect.

Optionally, the wireless communication module 204 includes a controller 2041, a voice data processor 2042, and a wireless signal transceiver 2043.

The controller 2041 is configured to control the switching of a working mode of the smart glasses. In one embodiment, the controller 2041 is an MCU (Microcontroller Unit).

The voice data processor 2042 is configured to process voice data. In one embodiment, the voice data processor 2042 is a DSP (Digital Signal Processing) or a voice data processing integrated circuit. The voice data processing integrated circuit may be a commonly used circuit, and its structure is not specifically limited in the present disclosure.

In another embodiment of the present disclosure, the sound pickup device 203 is a directional microphone, which is configured to directionally pick up a voice signal and then send the voice signal to the MCU/DSP for voice processing.

Further, the sound pickup device 102 also includes two microphones configured to pick up a voice signal from a second preset direction. The voice signal from the second preset direction can be picked up by the user through the two microphones on the smart glasses, which is used for issuing voice commands and answering phone calls. A sound pickup direction can be accurately determined by using two microphones for sound pickup, and noise reduction can be achieved by processing sound pickup data of the two microphones. The voice signal is picked up by the two microphones of the smart glasses, and noise-reduced voice is played through the speakers of the smart glasses to produce sound.

The wireless signal transceiver 2043 is configured to perform data interaction with the smart mobile terminal.

Optionally, the voice data processor 2042 includes a voice equalizer. The wireless signal transceiver 2043 is further configured to receive a volume adjustment control command sent by the smart mobile terminal and send it to the voice data processor 2042. The voice data processor 2042 is further configured to adjust sound data to be output to sound data with the frequency band and volume specified by the volume adjustment control command by using the voice equalizer, and send adjusted sound data to the speaker specified by the volume adjustment control command. The frequency band specified by the volume adjustment control command may be low frequency, medium frequency, or high frequency. Volume adjustment may be increasing the volume or decreasing the volume.

Further, the voice data processor 2042 is further configured to, in the call mode, perform voice equalization processing (using the voice equalizer) and output volume processing on data on a downlink channel; and to perform acoustic echo cancellation processing, beamforming processing and noise cancellation processing on data on an uplink channel by using preset Acoustic Echo Cancellation algorithm, Beamforming algorithm and Noise Cancellation algorithm.

Further, the voice data processor 2042 is further configured to, in the hearing assistance mode or the translation mode, perform feedback cancellation processing, voice activity detection processing, noise suppression processing, voice equalization processing, and user speech detection processing on the voice data by using preset Feedback Cancellation algorithm, voice activity detection processing, noise suppression algorithm, voice equalizer algorithm, and user speech detection algorithm; and to send the voice data processed by the voice equalization to a corresponding speaker for output. Meanwhile, the voice data processed by the voice equalization also serves as reference data for the feedback cancellation processing during processing.

Optionally, the smart glasses further include at least one sensor 207. The at least one sensor 207 is electrically connected to the wireless communication module 204.

The at least one sensor 207 is installed on an inner side and/or an outer side of the first temple 202A and/or the second temple 202B.

Specifically, the at least one sensor 207 may include, but is not limited to, at least one of a touch sensor, a proximity sensor, an accelerometer, a gyroscope, a magnetic induction sensor, and an inertial measurement unit.

Optionally, the inertial measurement unit is a 9-axis sensor. The 9-axis sensor is configured to collect motion data of the user (3-axis accelerometer data, 3-axis gyroscope data and 3-axis magnetometer data), and send the motion data to the smart mobile terminal through the wireless communication module 204 for monitoring a status of the user's head and body.

In one embodiment, the at least one sensor 207 includes the 9-axis sensor, at least one touch sensor, and at least one proximity sensor.

The at least one touch sensor is installed on the outer side of the first temple 202A and/or the second temple 202B.

Optionally, the at least one touch sensor is configured to detect a first control operation of the user, and send detected data of the first control operation to the controller 2041. The first control operation is used to adjust the volume. The controller 2041 is further configured to respond to the first control operation, control and adjust the volume of the sound output by the smart glasses according to the data of the first control operation.

The first control operation includes a control operation for increasing the volume and a control operation for decreasing the volume. The control operation for increasing the volume corresponds to a swiping action of the user's finger toward the ear on the touch sensor. The control operation for decreasing the volume corresponds to a swiping action of the user's finger toward the frame (i.e., away from the ear) on the touch sensor.

Optionally, the at least one touch sensor is further configured as an input device to detect a second control operation of the user, and send detected data of the second control operation to the controller 2041. The controller 2041 is further configured to respond to the second control operation, control the switching of the working mode of the smart glasses according to the data of the second control operation.

Optionally, the at least one proximity sensor is installed on the inner side of the first temple 202A and/or the second temple 202B, and is configured to detect whether the user wears or takes off the smart glasses, obtain the duration of time during which the user does not wear the smart glasses, and send a detection result to the controller 2041. The controller 2041 is configured to control the playing or pausing of music and to control the power on or off of the smart glasses 20 according to the detection result. For example, the music data is played when the proximity sensor detects that the user is wearing the smart glasses; the playing of the music data is stopped when the proximity sensor detects that the user takes off the smart glasses; and a shutdown operation is performed when the proximity sensor detects that the user has not worn the smart glasses for more than a preset duration.

A number of each type of the above sensors is preferably one to reduce the overall weight of the smart glasses. However, in specific applications, the number of each type of the above sensors is not limited to one, depending on actual requirements. For example, to improve the accuracy of the detection result, one proximity sensor may be disposed on each of the two temples.

Optionally, the controller 2041 is also configured to send the data obtained by each sensor to the smart mobile terminal via the wireless signal transceiver.

Optionally, the sound pickup device 203 may include a first directional microphone and a second directional microphone. The first directional microphone is configured to obtain voice data in front of the user, and the second directional microphone is configured to obtain voice data below the user. The first directional microphone and the second directional microphone may be respectively disposed at different positions of the temples. Further, the controller 2041 can also control the directional microphone at a corresponding position to pick up sound according to the working mode of the smart glasses 20, thereby reducing noise in the obtained voice data and improving a speed of signal processing.

Optionally, the smart glasses further include a battery 208. The battery 208 is installed on the first temple 202A and electrically connected to the wireless communication module 204. The battery 208 is configured to supply electrical power to all hardware components on the smart glasses, such as the wireless communication module 204, each sensor, each speaker, and each microphone.

Optionally, the smart glasses further include an input device, and the input device is electrically connected to the wireless communication module 204. The input device is disposed on at least one of the frame 201 and the two temples 202.

Optionally, the input device includes at least one of a touch sensor and at least one control button (not shown in the figure). The at least one control button is installed on the outside of the first temple 202A and/or the second temple 202B, and is electrically connected to the wireless communication module 204. The at least one control button is configured to trigger the wireless communication module 204 to control the switching of the working mode or operating state of the smart glasses. The operating state includes an idle state and a working state. The working state includes the call mode, the hearing assistance mode, and the translation mode.

Specifically, the wireless communication module 204 is further configured to switch the working mode of the smart glasses to the hearing assistance mode in response to a first switching command triggered by the user using the input device or a first voice command; and in the hearing assistance mode, to amplify the first voice data from the first preset direction.

The wireless communication module 204 is further configured to switch the working mode of the smart glasses to the translation mode in response to a second switching command triggered by the user using the input device or a second voice command; and in the translation mode, send the first voice data to the smart mobile terminal, receive second voice data sent by the smart mobile terminal, and send the second voice data to the target speaker for playing. The second voice data is obtained by translating the first voice data.

The wireless communication module 204 is further configured to switch the working mode of the smart glasses to the call mode in response to a third switching command triggered by the user using the input device or a third voice command; and in the call mode, send third voice data from the second preset direction obtained by the microphone to the target terminal, receive a fourth voice data sent by the target terminal, and output the fourth voice data to all speakers for playing.

When the user of the smart glasses uses the smart glasses to make a direct call to a user of the other terminal, the target terminal refers to the other terminal. When the user of the smart glasses uses the smart glasses to make a call with the user of the other terminal via the smart mobile terminal, the target terminal refers to the smart mobile terminal.

The first preset direction is directed toward a front of the user, and the second preset direction is directed toward a lower side of the user.

Various electronic components of the smart glasses can be connected via a bus.

It should be noted that a relationship between various components of the smart glasses may be a substitutional relationship or a superimposed relationship. That is, all the above components in the present embodiment may be installed on one pair of smart glasses, or a part of the above components may be selectively installed according to requirements. When the relationship between the various components of the smart glasses is the substitutional relationship, the smart glasses are further provided with a connection interface for a peripheral. The connection interface may be at least one selected from, for example, a PS/2 interface, a serial interface, a parallel interface, an IEEE 1394 interface, a USB (Universal Serial Bus) interface, and the like. The functionality of replaced components can be achieved through the peripheral connected to the connection interface, such as an external speaker, an external sensor, or the like.

The controller 2041 is also configured to determine whether there is a playback device establishing a data connection with the smart glasses, such as the external speaker or an external hearing aid. If the playback device exists, the second voice data or the amplified first voice data is sent to the playback device and played through the same. If the playback device does not exist, the second voice data or the amplified first voice data is output through a local speaker. In this way, when there is an independent playback device, the voice data is played by using the independent playback device, thereby reducing the power consumption of the smart glasses.

In the present embodiment, by obtaining the first voice data from the first preset direction using the at least one microphone of the smart glasses, amplifying the first voice data using the wireless communication module of the smart glasses and sending the amplified first voice data to the target speaker of the plurality of speakers for playing, where the target speaker and the at least one microphone are respectively disposed on different temples; the real-time hearing assistance function based on the smart glasses is realized, thereby expanding the functions of the smart glasses and enhancing the user engagement. Further, since there is no need to install additional hearing assistance devices on the smart glasses, the weight of the smart glasses can be reduced, the power consumption can be decreased, and the manufacturing cost of the smart glasses can be lowered. Meanwhile, since the amplified voice data is obtained from the specific direction by the microphone on one side and played by the speaker on the other side, echo can be reduced and the quality of the played sound can be improved. In addition, through the interaction between the smart glasses and the smart mobile terminal, a real-time translation function based on the smart glasses is further realized, and the functions of the smart glasses are further expanded. Moreover, since the voice data to be translated is obtained from a specific direction, the quality of the voice data to be translated can be improved, thereby enhancing the translation efficiency.

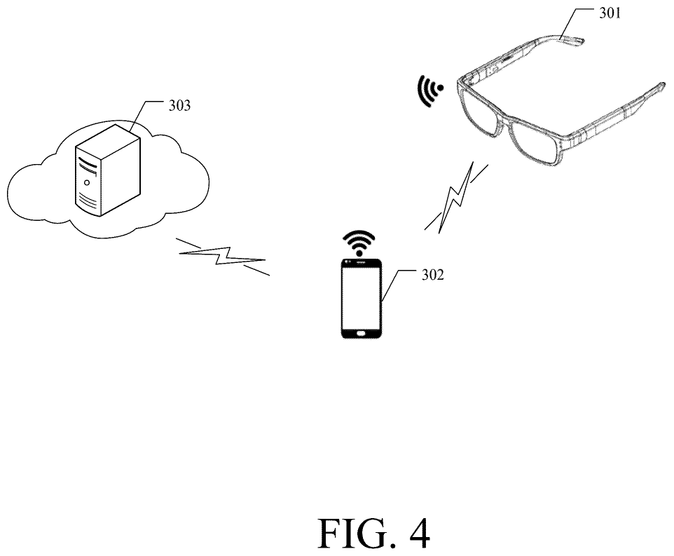

Referring to FIG. 4, FIG. 4 is a schematic view of an auxiliary system according to one embodiment of the present disclosure. As shown in FIG. 4, the auxiliary system includes smart glasses 301, a smart mobile terminal 302, and a cloud computing device 303.

The smart glasses 301 include two temples, a sound pickup device, a plurality of speakers, and a wireless communication module. The sound pickup device includes at least one microphone.

The wireless communication module is configured to control the switching of a working mode of the smart glasses in response to a user's control operation. The working mode includes a call mode, a hearing assistance mode, and a translation mode.

The at least one microphone is configured to, in the hearing assistance mode or the translation mode, obtain first voice data from a first preset direction.

The wireless communication module is configured to, in the hearing assistance mode, amplify the first voice data to obtain amplified voice data, and send the amplified voice data to a target speaker of the plurality of speakers for playing. The target speaker and the at least one microphone are respectively disposed on different temples.

The wireless communication module is further configured to, in the translation mode, send the first voice data to the smart mobile terminal, receive second voice data sent by the smart mobile terminal, and send the second voice data to the target speaker for playing. The second voice data is obtained by translating the first voice data.

The at least one microphone is further configured to, in the call mode, obtain third voice data from a second preset direction.

The wireless communication module is further configured to send the third voice data to a target terminal and receive fourth voice data sent by the target terminal.

The plurality of speakers is further configured to play the fourth voice data.

The specific structure and functions of the smart glasses 301 are referred to the relevant descriptions in the embodiments shown in FIGS. 1 to 3 above.

The smart mobile terminal 302 may include, but is not limited to: cellular phones, smartphones, other wireless communication devices, audio players, other media players, music recorders, video recorders, cameras, other media recorders, smart radios, laptop computers, Personal Digital Assistants (PDAs), Portable Multimedia Players (PMPs), Moving Picture Experts Group (MPEG-1 or MPEG-2) Audio Layer 3 (MP3) players, digital cameras, and smart wearable devices (e.g., smart watches, smart bracelets, and the like). The smart mobile terminal 302 is installed with an Android or IOS operating system.

The smart mobile terminal 302 is configured to interact with the smart glasses 301 and the cloud computing device 303. Specifically, for example: receiving the first voice data sent by the smart glasses 301, and translating the first voice data into the second voice data in a target language locally on the smart mobile terminal 302; or sending the first voice data or first text data corresponding to the first voice data to the cloud computing device 303 for translation, receiving second text data in a translated target language returned by the cloud computing device 303, converting the second text data into the second voice data, and sending the second voice data to the smart glasses 301. For another example, when performing target tasks such as playing music data or making calls, the music data being played and the received call voice data are sent to the smart glasses 301 and the like. A communication protocol used by the smart mobile terminal 302 when performing data interaction with the smart glasses 301 is consistent with a communication protocol used by the smart glasses 301.

Optionally, the smart mobile terminal 302 determines whether to send the first voice data or the first text data corresponding to the first voice data to the cloud computing device 303 according to a preset conversion flag.

Specifically, the smart mobile terminal 302 is further configured to obtain the preset conversion flag. If the preset conversion flag is a first flag, the first voice data is converted into the first text data, and the first text data is sent to the cloud computing device 303; if the preset conversion flag is a second flag, the first voice data is directly sent to the cloud computing device 303.

Further, the smart mobile terminal 302 is further configured to obtain a network speed and determine whether the network speed is greater than a preset speed. If the network speed is not greater than the preset speed, the conversion flag is set to the first flag; if the network speed is greater than the preset speed, the conversion flag is set to the second flag.

Further, the smart mobile terminal 302 is further configured to, in response to a user's setting operation, set the conversion flag to a flag indicated by the setting operation.

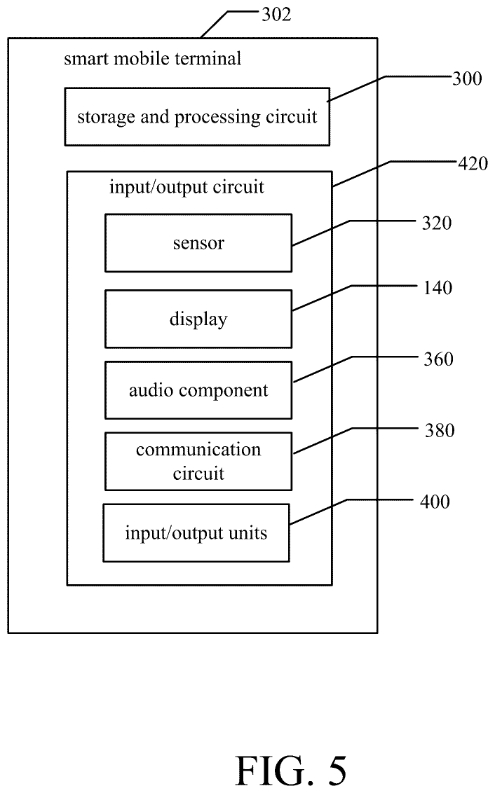

As shown in FIG. 5, the smart mobile terminal 302 may include a control circuit, and the control circuit may include a storage and processing circuit 300. The storage and processing circuit 300 may include a memory, such as a hard disk drive memory, a non-volatile memory (e.g., a flash memory or other electronically programmable limited-deletion memory for forming a solid-state drive, etc.), a volatile memory (e.g., a static or dynamic random access memory, etc.), and the like, and the embodiments of the present disclosure are not limited thereto. A processing circuit of the storage and processing circuit 300 can be used to control the operation of the smart mobile terminal 302. The processing circuit may be implemented based on one or more microprocessors, microcontrollers, digital signal processors, baseband processors, power management units, audio codec chips, application-specific integrated circuits, display driver integrated circuits, and the like.

The storage and processing circuit 300 may be configured to run software of the smart mobile terminal 302, for example, artificial intelligence butler applications, internet browsing applications, Voice over Internet Protocol (VOIP) phone call applications, email applications, media playback applications, operating system functions, and the like. These software programs may be configured to perform various control operations, such as data processing and analysis of motion data sent by the smart glasses 301 based on a preset analysis algorithm, image collection based on a camera, ambient light measurement based on an ambient light sensor, proximity sensor measurement based on a proximity sensor, information display functions implemented based on status indicators such as status indicator lights (e.g., light-emitting diodes), touch event detection based on a touch sensor, functions associated with displaying information on a plurality of (e.g., layered) displays, operations associated with performing wireless communication functions, operations associated with collecting and generating audio signals, control operations associated with collecting and processing button press event data, and other functions of the smart mobile terminal 302, and the like. The embodiments of the present disclosure are not limited thereto.

Further, the memory stores executable program code. The executable program code stored in the memory is invoked by a processor connected to the memory to execute relevant steps in the following method embodiments of the present disclosure, to implement various functions of the smart mobile terminal 302 in each embodiment of the present disclosure.

The smart mobile terminal 302 may further include an input/output circuit 420. The input/output circuit 420 may be used to allow the smart mobile terminal 302 to input and output data, that is, allow the smart mobile terminal 302 to receive data from external devices and also allow the smart mobile terminal 302 to output data from the smart mobile terminal 302 to external devices. The input/output circuit 420 may further include a sensor 320. The sensor 320 may include an ambient light sensor, a proximity sensor based on light and capacitance, a touch sensor (e.g., based on a light touch sensor and/or a capacitive touch sensor; the touch sensor can be part of a touch display screen or used independently as a touch sensor structure), an accelerometer, other sensors, and the like.

The input/output circuit 420 may further include one or more displays, such as display 140. The display 140 may include one or any combination of a liquid crystal display, an organic light-emitting diode display, an electronic ink display, a plasma display, and displays using other display technologies. The display 140 may include a touch sensor array (that is, the display 140 may be a touch display screen). The touch sensor may be a capacitive touch sensor formed by an array of transparent touch sensor electrodes (e.g., indium tin oxide (ITO) electrodes), or may be a touch sensor formed using other touch technologies, such as acoustic wave touch, pressure-sensitive touch, resistive touch, optical touch, and the like. The embodiments of the present disclosure are not limited thereto.

The smart mobile terminal 302 may further include an audio component 360. The audio component 360 can be configured to provide audio input and output functions for the smart mobile terminal 302. The audio component 360 of the smart mobile terminal 302 may include a speaker, a sound pickup device, a buzzer, a tone generator, and other components for generating and detecting sound.

A communication circuit 380 may be configured to provide the smart mobile terminal 302 with an ability to communicate with the external devices. The communication circuit 380 may include analog and digital input/output interface circuits, and a wireless communication circuit based on radio frequency signals and/or optical signals. The wireless communication circuit of the communication circuit 380 may include a radio frequency transceiver circuit, a power amplifier circuit, a low-noise amplifier, a switch, a filter, and an antenna. For example, the wireless communication circuit of the communication circuit 380 may include a circuit used to support Near Field Communication (NFC) by transmitting and receiving near-field connected electromagnetic signals. For example, the communication circuit 380 may include a near-field communication antenna and a near-field communication transceiver. The communication circuit 380 may further include a cellular telephone transceiver and antenna, as well as wireless local area network transceiver circuits and antennas such as Bluetooth, WiFi, ZigBee, DLNA, UWB, and RFID, and the like.

The smart mobile terminal 302 may further include a battery, a power management circuit, and other input/output units 400. The input/output units 400 may include a button, a joystick, a click wheel, a scroll wheel, a touchpad, a keypad, a keyboard, a camera, a light-emitting diode, other status indicators, and the like.

An operation of the smart mobile terminal 302 can be controlled by the user inputting commands through the input/output circuit 420, and status information and other outputs from the smart mobile terminal 302 can be received by using the output data of the input/output circuit 420.

Further, the smart mobile terminal 302 is further configured to pair with the smart glasses 301 based on the Bluetooth protocol, and after successful pairing, send the music data being played to the smart glasses 301, so that the music data can be played through the smart glasses 301.

The smart glasses 301 are further configured to send the first voice data to be translated to the smart mobile terminal 302 for translation after successful pairing.

Optionally, the smart mobile terminal 302 is also configured to obtain GPS data through a GPS module configured on the smart mobile terminal, and send the obtained GPS data to the smart glasses 301 for positioning of the smart glasses 301.

Optionally, the smart mobile terminal 302 is further configured to receive and store the motion data sent by the smart glasses 301 in real time, calculate a motion indicator based on the motion data and the GPS data, generate real-time voice data for notifying or reminding the user of their motion status based on a calculation result, and send the real-time voice data to the smart glasses 301 for output. The real-time voice data includes notification or reminder voices regarding the calculation result of the motion indicator.

Specifically, the smart mobile terminal 302 may be installed with a client program, such as an artificial intelligence butler App. Through the App, operations such as data interaction with the smart glasses 301 may be performed. Based on a user operation on the App, a parameter of the smart glasses 301 may be configured, and the motion data sent by the smart glasses 301 may be processed and analyzed, such as running index calculation, posture monitoring, reminders, and the like.

The music data and the real-time voice data belong to the data of the downlink channel of the smart glasses 301. Received music data and the real-time voice data are processed for voice equalization and output volume control by the smart glasses 301 via the voice data processor 1042, and then sent to the first speaker 201 and the second speaker 202 for output.

Specifically, the motion data includes data obtained by the smart glasses 301 through a 9-axis sensor (that is, Ax, Ay, Az; Gx, Gy, Gz; Mx, My, Mz). The motion indicator is a running indicator, which includes: pace, distance, number of steps, left-right head balance, step length, and step frequency. The 9-axis sensor refers to the accelerometer, the gyroscope, and the magnetic induction sensor. Data measured by these three types of sensors can all be decomposed into forces along three directional axes X, Y, and Z in a spatial coordinate system, therefore, they can also be called 3-axis accelerometer, 3-axis gyroscope, and 3-axis magnetic induction sensor.

The smart mobile terminal 302 is further configured to perform indicator calculation, posture monitoring, and exercise reminder operations based on the motion data obtained by the 9-axis sensor and local GPS data, and display an indicator calculation result in real time through the display of the smart mobile terminal 302. Further, voice prompt information may be generated by the smart mobile terminal 302 based on the indicator calculation result, and the voice prompt information is sent to the smart glasses 301 via Bluetooth, thereby providing real-time voice notification or reminder to the user through the smart glasses 301.

Optionally, the smart mobile terminal 302 is further configured to respond to a voice command sent by the smart glasses 301 to perform operations such as making, answering or hanging up a call; and during the call, send received call voice data to the smart glasses 301, so that the call voice data can be played through the speaker on the smart glasses 301.

The voice command is obtained by the voice data processor of the smart glasses 301, using a preset voice recognition algorithm to perform voice command recognition processing on the voice data obtained by the sound pickup device of the smart glasses 301.

It is understandable that at least two directional and/or omnidirectional microphones are disposed on the main body of the smart glasses 301 in the present disclosure, and the user can obtain the voice data through the microphones on the smart glasses 301 for issuing the voice command and answering the call. The sound produced by the user is picked up by the microphones on the smart glasses 301, and played through the speaker of the smart glasses 301 after noise reduction processing. Therefore, during the call, the smart mobile terminal 302 can be placed in a pocket or on a table by the user, and the user's hands can be freed up for other purposes, thereby improving the convenience of answering the call.

The cloud computing device 303 may be, for example, a cloud server or a server cluster, configured to perform data interaction with the smart mobile terminal 302, store data sent by the smart mobile terminal 302 and/or the smart glasses 301 (e.g., all sensor data obtained by the smart glasses), and process the data based on preset processing logic. Specifically, the cloud computing device 303 receives the first voice data or the first text data corresponding to the first voice data sent by the smart mobile terminal 302, then translates the first voice data or the first text data into the second text data in the target language, and returns the second text data to the smart mobile terminal 302. For example, assuming a source language is Chinese and the target language is English, if Chinese voice data 1 is sent by the smart mobile terminal 302, the Chinese voice data 1 is first converted into Chinese text data 1, and then the Chinese text data 1 is translated into English text data 2 and sent to the smart mobile terminal 302; if the Chinese text data 1 corresponding to the Chinese voice data 1 is sent by the smart mobile terminal 302, the Chinese text data 1 is translated into the English text data 2 and sent to the smart mobile terminal 302.

A recognition operation of the source language may be performed by the smart mobile terminal 302, or by the cloud computing device 303. If the recognition operation of the source language is performed by the smart mobile terminal 302, when the first voice data is sent by the smart mobile terminal 302, the identification information of the source language and the target language is also sent to the cloud computing device 303 together, so that the source language and target language can be determined by the cloud computing device 303 based on the identification information.

Optionally, the source language and the target language may also be determined by the smart mobile terminal 302 based on a user's selection operation on the smart glasses 301 or the smart mobile terminal 302.

Specifically, the source language and/or the target language may also be selected by the user via the control button or the touch sensor on the smart glasses 301 or the smart mobile terminal 302. If the selection operation is performed by the user through the smart glasses 301, when the first voice data is sent to the smart mobile terminal 302 by the smart glasses 301, the identification information of the source language and/or the target language selected by the user is also sent to the smart mobile terminal 302.

In a practical application, when the user performs the selection operation through the smart glasses 301, the smart glasses 301 can also output a corresponding voice prompt in real time according to the selection operation of the user, thereby helping the user quickly select the source language and/or the target language from a plurality of alternative languages.

In one embodiment, the Bluetooth protocol is adopted as a communication protocol between the smart mobile terminal 302 and the smart glasses 301, and the Cellular Mobile Communication protocol (e.g., 2G, 3G, 4G, 5G protocols, and the like.) is adopted as a communication protocol between the cloud computing device 303 and the smart mobile terminal 302.

It should be noted that a specific implementation process of the functions of the smart glasses 301, the smart mobile terminal 302, and the cloud computing device 303 in the present embodiment may also refer to relevant descriptions in other embodiments.

In the present embodiment, the real-time hearing assistance and real-time translation functions based on the smart glasses 301 are realized, thereby expanding the functions of the smart glasses 301 and improving the user engagement. Moreover, since no additional hearing assistance devices need to be installed on the smart glasses 301, the weight of the smart glasses 301 can be reduced, the power consumption can be decreased, and the manufacturing cost of the smart glasses 301 can be lowered. Meanwhile, since voice data to be amplified is obtained from a specific direction by a microphone on one side, and the amplified voice data is played by a speaker on the other side, echo can be reduced, and the quality of played voice data and voice data to be translated can be improved, thereby increasing translation efficiency.

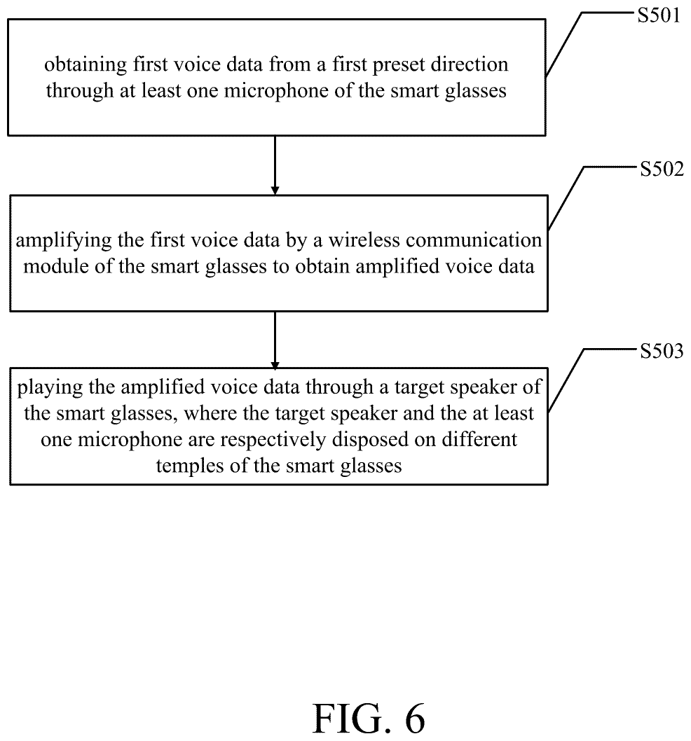

Referring to FIG. 6, FIG. 6 is a schematic diagram of an implementation flow of a hearing assistance method based on smart glasses according to one embodiment of the present disclosure. The method can be applied to the smart glasses as shown in FIGS. 1 to 3. As shown in FIG. 6, the method includes the following steps:

Step (S501), obtaining first voice data from a first preset direction through at least one microphone of the smart glasses;

Step (S502), amplifying the first voice data by a wireless communication module of the smart glasses to obtain amplified voice data; and

Step (S503), playing the amplified voice data through a target speaker of the smart glasses, where the target speaker and the at least one microphone are respectively disposed on different temples of the smart glasses.

In the present embodiment, by using the at least one microphone of the smart glasses to obtain the first voice data from the first preset direction, and using the wireless communication module of the smart glasses to amplify the first voice data and send the amplified first voice data to the target speaker of a plurality of speakers for playing, where the target speaker and the at least one microphone are respectively disposed on different temples; a real-time hearing assistance function based on the smart glasses is realized, thereby expanding the functions of the smart glasses and enhancing the user engagement. Meanwhile, since the voice data to be amplified is obtained from a specific direction by a microphone on one side, and the amplified voice data is played by a speaker on the other side, echo can be reduced and the quality of played sound can be improved.

Optionally, in another embodiment of the present disclosure, the smart glasses 301 have an idle state and a working state that are freely switchable, and in the working state, the smart glasses 301 further include three working modes: a hearing assistance mode, a call mode, and a translation mode. In the call mode, the user may use the telephone call function of the smart glasses 301 to conduct a telephone conversation with a person at the other end of the network via a mobile communication terminal and a wireless communication network. In the hearing assistance mode, the user may use the hearing assistance function of the smart glasses to have a face-to-face conversation with other persons. In the translation mode, the user may use the translation function of the smart glasses for real-time translation, thereby helping the user better understand voice contents from speakers of different languages.

In another embodiment of the present disclosure, the method further includes the following steps:

Switching the working mode of the smart glasses to the hearing assistance mode through the wireless communication module in response to a first switching command.

The step (S502) of amplifying the first voice data by the wireless communication module of the smart glasses to obtain the amplified voice data includes:

In the hearing assistance mode, amplifying the first voice data through the wireless communication module to obtain the amplified voice data.

Optionally, in another embodiment of the present disclosure, a hearing assistance function can further be automatically provided for a specific user. Outputting second voice data includes: determining whether a currently logged-in user is a target user; if the currently logged-in user is the target user, the second voice data is amplified by the wireless communication module and the amplified second voice data is output through the target speaker; if the currently logged-in user is not the target user, the second voice data is output\through the target speaker.

Specifically, before using various functions provided by the smart glasses 301, a corresponding user account is registered by the user through the smart mobile terminal, and after logging into a operating system of the smart glasses 301 using the user account through the smart mobile terminal, whether the user account is used by a specific user with hearing assistance needs is set. If the user selects that the user account is to be used by the specific user with hearing assistance needs, a corresponding tag is added to the user account by the smart mobile terminal according to a user's setting operation.

Each time the Bluetooth pairing between the smart glasses and the smart mobile terminal is completed, a query request is sent to the smart mobile terminal to confirm whether the currently logged-in user is the target user, and a query result is stored locally. Each time before the second voice data is output, whether an additional hearing assistance function is needed is determined by the smart glasses according to the locally stored query result, that is, whether the translated voice data needs to be amplified. The smart mobile terminal responds to the query request, confirms whether the currently logged-in user is the target user according to the tag, and returns a confirmation result to the smart glasses as the query result.

In another embodiment of the present disclosure, the method further includes the following steps:
Step (S601), switching the working mode of the smart glasses to the translation mode through the wireless communication module responding to a second switching command;
Step (S602), in the translation mode, obtaining the first voice data from the first preset direction through the at least one microphone;
Step (S603), sending the first voice data to the smart mobile terminal through the wireless communication module, and receiving second voice data sent by the smart mobile terminal, where the second voice data is obtained by translating the first voice data; and
Step (S604), playing the second voice data through the target speaker.

Specifically, for real-time language translation, a voice signal is picked up by the smart glasses from the microphone, and the voice signal is locally processed by the smart glasses and sent to the smart mobile terminal. After the first voice data is received by the smart mobile terminal, the first voice data may be translated into the second voice data in the target language by using a local translation engine.

Alternatively, the voice signal from the source language is translated to the target language in real time by an application program built into the smart mobile terminal based on a cloud-based AI (Artificial Intelligence) system, and the translated voice signal is sent back to the smart glasses and played for the user.

Specifically, the smart mobile terminal may, according to a preset conversion flag, select to send the first voice data or the first text data corresponding to the first voice data to a cloud computing device for translation, receive the second text data in the target language returned by the cloud computing device, convert the second text data into the second voice data, and send the second voice data to the smart glasses.

Optionally, while the second voice data is sent to the smart glasses by the smart mobile terminal, the second text data may be displayed through a local display, thereby helping the user more intuitively understand the conversation content of the other party in a graphical and/or textual way.

In another embodiment of the present disclosure, the method further includes the following steps:
Step (S701), switching the working mode of the smart glasses to a call mode through the wireless communication module responding to a third switching command;
Step (S702), in the call mode, obtaining third voice data from a second preset direction through the at least one microphone, and sending the third voice data to a target terminal through the wireless communication module; and
Step (S703), receiving fourth voice data sent by the target terminal through the wireless communication module, and playing the fourth voice data through the plurality of speakers of the smart glasses.

The first preset direction is directed toward the front of the user, and the second preset direction is directed toward a lower side of the user, that is, in a direction of a user's mouth.

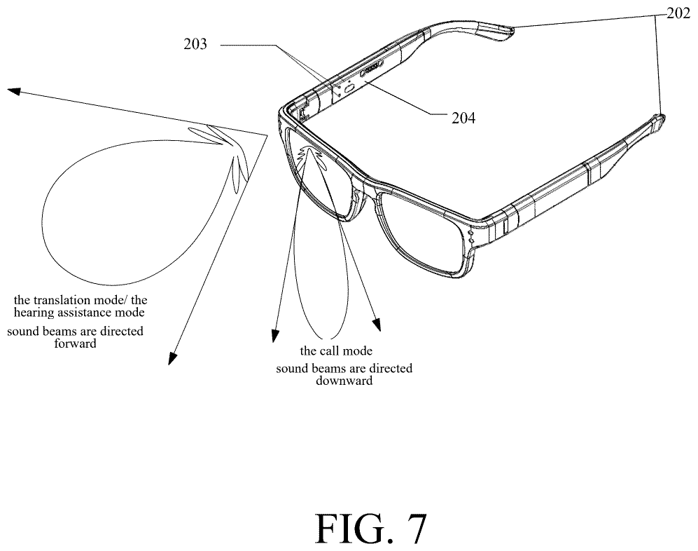

In other words, as shown in FIG. 7, in the translation mode and the hearing assistance mode, audio beams are directed forward, and voice signals are captured from the front by the microphones. In the call mode, the voice signals are captured from the direction of the user's mouth, that is, the voice signals are captured downwards by the microphone.

Furthermore, in the translation mode and the hearing assistance mode, only the speaker on one temple of the smart glasses may be used to output the voice data, that is, sound is picked up on one side and played on the other side, thereby reducing echo. In the call mode, the speakers on all the temples may be used to output the voice data. Playback requirements of different working modes can be met, thereby achieving an excellent playback effect.

Optionally, the above switching commands may be triggered by the user through an input device configured on the smart glasses, such as a physical button or a virtual button (touch sensor). For example, the smart glasses can be provided with a plurality of status control buttons, which correspond to different operating states and working modes respectively. The smart glasses respond to the switching command triggered by a user's control operation of pressing a button through the wireless communication module, and control the smart glasses to enter the operating state or the working mode corresponding to the pressed button. Optionally, the above switching commands may further be triggered by the user through voice commands.

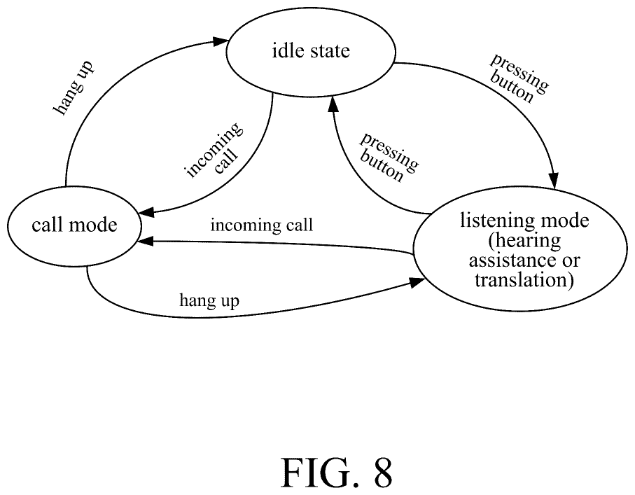

Optionally, either the hearing assistance mode or the translation mode may be set as a frequently-used listening mode according to a user's mode selection operation on the smart glasses or the smart mobile terminal. As shown in FIG. 8, if the smart glasses are in the idle state, the physical button or the virtual button (touch sensor) can be used to manually switch between the call mode and the listening mode. For example, if the smart glasses are in the call mode, the smart glasses are switched from the call mode to the listening mode by pressing the physical button, and switched back to the call mode by pressing the physical button again, thereby reducing a number of buttons, lowering the manufacturing cost, improving the intelligence level of operation, and making the operation more in line with the user's habits.

Alternatively, when a user's target control operation is detected by the touch sensor, the wireless communication module responds to the switching command triggered by the target control operation, and controls the working mode of the smart glasses to switch to the call mode or the listening mode. A specific form of the target control operation can be customized by the user, for example, an action of long-pressing the touch sensor or a preset swipe gesture can be set as the target control operation.

Further, various corresponding algorithms may be executed on the voice data by the above DSP of the wireless communication module.

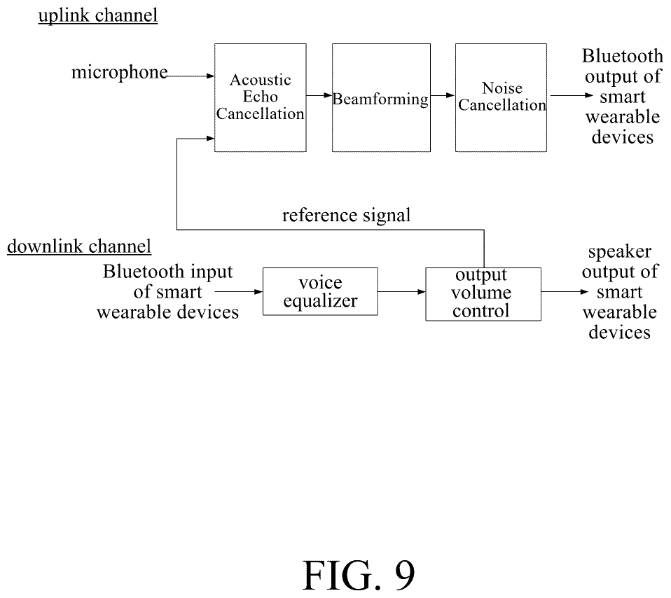

As shown in FIG. 9, in the call mode, voice equalization processing and output volume processing are performed on the data of the downlink channel by the smart glasses through the DSP, and acoustic echo cancellation processing, first beamforming processing, and noise suppression processing are sequentially performed on the data of the uplink channel. The data of the downlink channel is input through the wireless signal transceiver of the wireless communication module. The wireless signal transceiver primarily uses Bluetooth protocol as the communication protocol.

Further, in the call mode, the smart glasses sequentially perform voice equalization processing and output volume control processing via the DSP on the call voice data from the smart mobile terminal, which is input through the wireless signal transceiver (the wireless Bluetooth input of the smart glasses as shown in FIG. 9), and send the call voice data after the output volume control processing to the speakers of the smart glasses for output. Meanwhile, the voice data obtained by the sound pickup device is subjected to the acoustic echo cancellation processing by the DSP using the call voice data after output volume control processing as a reference signal, followed by the beamforming processing and the noise suppression processing; and the data after the noise suppression processing is output to the smart mobile terminal through the wireless signal transceiver.

Since a distant voice is played through the speaker, a distant voice signal may be picked up by the microphone, thereby creating a loop. The acoustic echo cancellation processing performed on the voice data of the uplink channel is to compare the output signal of the speaker with the input signal of the microphone by using an echo cancellation algorithm, thereby eliminating the echo and breaking a loop link between the speaker and the microphone.

The noise suppression processing performed on the voice data of the uplink channel is to reduce or eliminate the volume of noise by using a noise suppression algorithm, while simultaneously amplifying the volume of the other party's voice. By using the noise suppression algorithm, even if the user is in an environment with high ambient noise, the distant party cannot hear the ambient noise and can only hear a clear voice of the user of the smart glasses.

The voice equalization processing performed on the voice data of the downlink channel is to perform the voice equalization processing on a distant voice signal using a voice equalizer, to enhance frequency signals poorly perceived by the user, thereby achieving a purpose of compensating for the frequency signals poorly perceived by the user.

The output volume control processing performed on the voice data of the downlink channel is to adjust the output volume of the speaker by using an output volume control algorithm.

Optionally, the wireless signal transceiver may adopt at least one of the Bluetooth protocol, Wireless Fidelity protocol, Near Field Communication protocol, Zigbee, Digital Living Network Alliance protocol, Carrierless Communication protocol, Radio Frequency Identification protocol, and Cellular Mobile Communication protocol as a communication protocol for data interaction with the smart mobile terminal.

Further, in another embodiment of the present disclosure, before obtaining the first voice data or the third voice data through the sound pickup device, the method further includes:

Performing Bluetooth pairing with the smart mobile terminal through the wireless communication module based on the Bluetooth protocol, to establish a data transmission channel between the smart glasses and the smart mobile terminal. All subsequent data interactions between the smart glasses and the smart mobile terminal can be conducted through the data transmission channel.

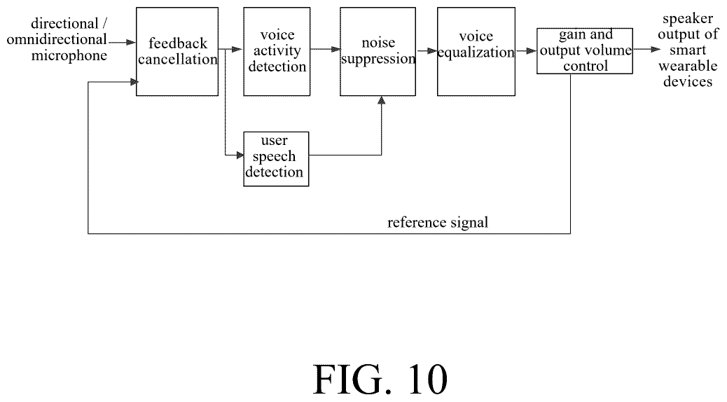

As shown in FIG. 10, in the hearing assistance mode, to assist with hearing loss, the smart glasses perform the feedback cancellation processing, the voice activity detection processing, the noise suppression processing, the voice equalization processing, and the user speech detection processing on the voice data through the DSP; the voice data after the voice equalization processing is sent to the speaker of the smart glasses for output; meanwhile, the voice data after the voice equalization processing is used as reference data for the feedback cancellation processing. Further, before the voice data after the voice equalization processing is sent to the speaker of the smart glasses for output, output gain processing and output volume control processing may also be performed on the voice data after the voice equalization processing. A specific processing method is the same as the output volume control processing method shown in FIG. 9; the details can refer to the relevant description of FIG. 9 above, and not be repeated here.

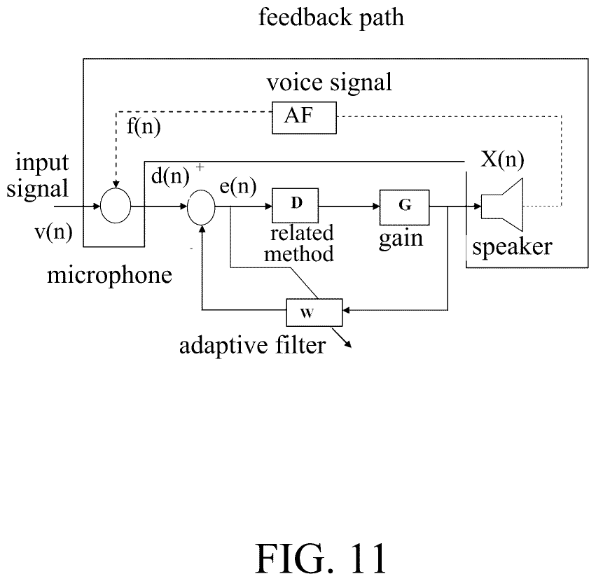

In the hearing assistance mode, sound waves output by the speaker are immediately received by the microphone array and form a loop, thereby generating harsh howling. The feedback cancellation processing uses a feedback cancellation algorithm to eliminate echoes by comparing the output signal of the speaker with the input signal of the microphone array, and to break the loop link between the speaker and the microphone array. Specifically, as shown in FIG. 11, the voice signal is obtained from the front by the microphone; however, since a general microphone is omnidirectional, the voice signal output from the speaker is also simultaneously obtained by the microphone. The voice signal of the speaker is also fed back to the input of an adaptive filter through internal wiring. An LMS (Least Mean Square) adaptive filter coefficient is adjusted by the adaptive filter according to the output data of the previous speaker, thereby removing the signal output by the speaker (i.e., f (n)) from the input of the microphone.

In addition, in the hearing assistance mode, it is necessary to amplify the other party's voice so that a user with hearing impairments can clearly hear what the other party is saying; however, during a process of amplifying the sound, the voice and the noise are amplified together, thereby causing discomfort to the user. The noise suppression processing uses a noise suppression algorithm to reduce or eliminate noise volume, and to amplify the volume of the other party's voice simultaneously. Specifically, the algorithm divides the voice signal of each frame into speech and non-speech. If the frame is detected as a non-speech frame, the algorithm uses the voice signal of the frame to update an average noise energy value. If the frame is defined as a speech frame, the voice signal of the frame is subtracted by the average noise energy value, thereby achieving noise suppression.

In addition, in the hearing assistance mode, the user with hearing impairments may just be unable to hear or clearly perceive sounds at a specific frequency. The voice equalization processing uses the voice equalizer to enhance a sound signal at the specific frequency, thereby achieving a purpose of compensating for the sound signal at the specific frequency.

In addition, since the microphone array of the smart glasses is close to the user's mouth, when the user speaks, a strong signal is received by the microphone array and played through the speaker of the smart glasses. In this way, the user may hear his or her own voice through the speaker when speaking. The user speech detection processing uses a user speech detection algorithm to continuously detect a signal received by the microphone array, and perform average energy estimation analysis and detection. If an average energy estimated value is lower than a preset average energy threshold, the signal is detected as the user's voice.

The voice activity detection processing is similar to the user speech detection processing, except that an average energy threshold thereof is lower than the average energy threshold of the user speech detection algorithm, thereby detecting the voice of the other party.

Optionally, in another embodiment of the present disclosure, an independent playback device (e.g., an external speaker, an external hearing aid) may also be used to play the voice data. The step of outputting the amplified voice data or the second voice data may include: determining whether there is a playback device establishing a data connection with the smart glasses by the wireless communication module. If the playback device exists, the second voice data or the amplified voice data is sent to the playback device by the wireless communication module, so that the amplified voice data or the second voice data is played through the playback device. If the playback device does not exist, the amplified voice data or the second voice data is output through the target speaker. In this way, when there is the independent playback device, the power consumption of the smart glasses can be reduced by using the independent playback device to play the voice data. The wireless communication module of the smart glasses may determine whether there is the playback device establishing the data connection with the smart glasses according to a local Bluetooth pairing log and a connection status of the peripheral interface.

In the embodiments provided in the present disclosure, it is understandable that the smart glasses, the auxiliary system, and the hearing assistance method disclosed above may also be implemented in other manners. For example, a plurality of modules or components may be combined or integrated into another system, or some features may be ignored or not executed. Further, the mutual connections, direct connections, or communication connections shown or discussed may be indirect connections or communication connections through some interfaces, devices, or modules, and may be electrical, mechanical, or other forms.

It should be noted that, for a simple description, each of the above method embodiments is described as a series of actions, however, those skilled in the art should understand that the present disclosure is not limited to the described order of actions, because according to the present disclosure, some steps may be performed in other orders or simultaneously. Further, those skilled in the art should also understand that the embodiments described in the specification are preferred embodiments, and the involved actions and modules are not necessarily essential to the present disclosure.

In the above embodiments, the description of each embodiment focuses on different aspects; for parts not described in detail in one embodiment, reference may be made to the relevant descriptions of other embodiments.

The above is a description of the smart glasses, the hearing assistance method, and the auxiliary system provided in the present disclosure. For those skilled in the art, based on the spirit of the present disclosure, there may be changes in the specific implementation manners and application scopes. Therefore, the content of this specification should not be construed as a limitation on the present disclosure.

What is claimed is:

1. Smart glasses for hearing assistance, comprising:
two temples;
a sound pickup device;
a plurality of speakers; and
a wireless communication module,
and wherein the plurality of speakers and the sound pickup device are disposed on at least one of the two temples, the wireless communication module is disposed in a cavity of either one of the two temples and electrically connected to the sound pickup device and the plurality of speakers, and the sound pickup device comprises at least one microphone configured to obtain first voice data from a first preset direction; and
the wireless communication module is configured to amplify the first voice data to obtain amplified voice data, and send the amplified voice data to a target speaker of the plurality of speakers for playing; and the target speaker and the at least one microphone are respectively disposed on different temples.

2. The smart glasses of claim 1, further comprising a frame and an input device, and wherein the input device is electrically connected to the wireless communication module, and the input device is disposed on at least one of the two temples and/or the frame;
the wireless communication module is further configured to switch a working mode of the smart glasses to a hearing assistance mode in response to a first switching command triggered by a user using the input device or a first voice command; and
the wireless communication module is further configured to, in the hearing assistance mode, amplify the first voice data.

3. The smart glasses of claim 2, wherein the wireless communication module is further configured to switch the working mode of the smart glasses to a translation mode in response to a second switching command triggered by the user using the input device or a second voice command; and
the wireless communication module is further configured to, in the translation mode, send the first voice data to the smart mobile terminal, receive second voice data sent by the smart mobile terminal, and send the second voice data to the target speaker for playing, and wherein the second voice data is obtained by translating the first voice data.

4. The smart glasses of claim 2, wherein the wireless communication module is further configured to switch the working mode of the smart glasses to a call mode in response to a third switching command triggered by the user using the input device or a third voice command;
the at least one microphone is further configured to, in the call mode, obtain third voice data from a second preset direction;
the wireless communication module is further configured to send the third voice data to a target terminal and receive fourth voice data sent by the target terminal; and
the plurality of speakers is further configured to play the fourth voice data.

5. The smart glasses of claim 4, wherein the first preset direction is directed toward a front of the user; and the second preset direction is directed toward a lower side of the user.

6. A hearing assistance method based on smart glasses, wherein the smart glasses comprise two temples, a wireless communication module, and a sound pickup device and a plurality of speakers electrically connected to the wireless communication module; the sound pickup device comprises at least one microphone; and the hearing assistance method comprises:
obtaining first voice data from a first preset direction through the at least one microphone;
amplifying the first voice data by the wireless communication module to obtain amplified voice data; and
playing the amplified voice data through a target speaker of the plurality of speakers, and wherein the target speaker and the at least one microphone are respectively disposed on different temples.

7. The hearing assistance method of claim 6, further comprising:
switching a working mode of the smart glasses to a hearing assistance mode through the wireless communication module responding to a first switching command;
and wherein the amplifying the first voice data by the wireless communication module to obtain the amplified voice data comprises:
in the hearing assistance mode, amplifying the first voice data through the wireless communication module to obtain the amplified voice data.

8. The hearing assistance method of claim 6, further comprising:
switching the working mode of the smart glasses to a translation mode through the wireless communication module responding to a second switching command;
in the translation mode, obtaining the first voice data through the at least one microphone;
sending the first voice data to a smart mobile terminal through the wireless communication module, and receiving second voice data sent by the smart mobile terminal, and wherein the second voice data is obtained by translating the first voice data; and
playing the second voice data through the target speaker.

9. The hearing assistance method of claim 8, wherein the smart mobile terminal is configured to receive the first voice data sent by the smart glasses; according to a preset conversion flag, select to send the first voice data or first text data corresponding to the first voice data to a cloud computing device for translation; receive second text data in a target language returned by the cloud computing device; convert the second text data into the second voice data; and send the second voice data to the smart glasses.

10. The hearing assistance method of claim 6, further comprising:
switching the working mode of the smart glasses to a call mode through the wireless communication module responding to a third switching command;
in the call mode, obtaining third voice data from a second preset direction through the at least one microphone;
sending the third voice data to a target terminal through the wireless communication module; and
receiving fourth voice data sent by the target terminal through the wireless communication module, and playing the fourth voice data through the plurality of speakers.

11. The hearing assistance method of claim 10, wherein the first preset direction is directed toward a front of a user; and the second preset direction is directed toward a lower side of the user.

12. An auxiliary system, comprising smart glasses and a smart mobile terminal,
the smart glasses comprising two temples, a sound pickup device, a plurality of speakers, and a wireless communication module, and wherein the plurality of speakers and the sound pickup device are disposed on at least one of the two temples, the wireless communication module is disposed in a cavity of either one of the two temples and electrically connected to the sound pickup device and the plurality of speakers, and the sound pickup device comprises at least one microphone;
the wireless communication module is configured to control switching of a working mode of the smart glasses in response to a user's control operation, and the working mode comprises a hearing assistance mode and a translation mode;
the at least one microphone is configured to, in the hearing assistance mode or the translation mode, obtain first voice data from a first preset direction;
the wireless communication module is configured to, in the hearing assistance mode, amplify the first voice data to obtain amplified voice data, and send the amplified voice data to a target speaker of the plurality of speakers for playing, and wherein the target speaker and the at least one microphone are respectively disposed on different temples;
the wireless communication module is further configured to, in the translation mode, send the first voice data to the smart mobile terminal;
the smart mobile terminal is configured to receive the first voice data, and send second voice data to the wireless communication module, and wherein the second voice data is obtained by translating the first voice data; and
the wireless communication module is further configured to receive the second voice data sent by the smart mobile terminal, and send the second voice data to the target speaker for playing.

13. The auxiliary system of claim 12, further comprising a cloud computing device,
and wherein the smart mobile terminal is further configured to send the first voice data or first text data corresponding to the first voice data as data to be translated to the cloud computing device;
the cloud computing device is configured to translate the data to be translated into second text data in a target language, and send the second text data to the smart mobile terminal; and
the smart mobile terminal is further configured to convert the second text data into the second voice data, and send to the smart glasses.

14. The auxiliary system of claim 13, wherein the smart mobile terminal is further configured to obtain a preset conversion flag, when the preset conversion flag is a first flag, the first voice data is converted into the first text data, and the first text data is sent to the cloud computing device; and when the preset conversion flag is a second flag, the first voice data is sent to the cloud computing device.

15. The auxiliary system of claim 14, wherein the smart mobile terminal is further configured to obtain a network speed and determine whether the network speed is greater than a preset speed, when the network speed is not greater than the preset speed, the conversion flag is set to the first flag; and when the network speed is greater than the preset speed, the conversion flag is set to the second flag.

16. The auxiliary system of claim 14, wherein the smart mobile terminal is further configured to, in response to a user's setting operation, set the conversion flag to a flag indicated by the user's setting operation.

17. The auxiliary system of claim 12, wherein the working mode further comprises a call mode;
the at least one microphone is further configured to, in the call mode, obtain third voice data from a second preset direction;
the wireless communication module is further configured to send the third voice data to a target terminal, and receive fourth voice data sent by the target terminal; and
the plurality of speakers is further configured to play the fourth voice data.
